(19) United States
(12) Patent Application Publication
(10) Pub. No.: US 2026/0271888 A1
(43) Pub. Date: Sep. 17, 2026

(54) SYSTEMS AND METHODS FOR PREDICTING DRY MATTER INTAKE IN ANIMALS USING MACHINE LEARNING

(71) Applicant: West Virginia University Board of Governors on Behalf of West Virginia University, Morgantown, WV (US)

(72) Inventors: Matthew WILSON, Dilliner, PA (US); Domingo MATA-PADRINO, Morgantown, WV (US); Nathan BLAKE, Morgantown, WV (US); Matthew WALKER, Morgantown, WV (US); Ida HOLASKOVA, Morgantown, WV (US); Jason HUBBART, Morgantown, WV (US)

(21) Appl. No.: 19/472,862

(22) PCT Filed: Mar. 28, 2024
(86) PCT No.: PCT/US2024/022001

§ 371 Date: Oct. 6, 2025

Related U.S. Application Data
(60) Provisional application No. 63/457,310, filed on Apr. 5, 2023.

(51) Int. Cl. A01K 29/00; G06N 20/20; G06Q 50/02

(52) U.S. Cl. CPC A01K 29/005; G06N 20/20; G06Q 50/02

(57) ABSTRACT

A computing system may receive data comprising values of a set of variables corresponding to a plurality of animals, the set of the variables including a water intake and a dry matter intake. A computing system can train a machine learning model on the data to provide values of dry matter intake based on the values of the set of the variables. A computing system can after training, provide the machine learning model with input values of at least a subset of the variables associated with at least one animal to generate a value of dry matter intake for the at least one animal.

### CROSS REFERENCE TO RELATED APPLICATIONS

This application claims priority to and the benefit of U.S. Provisional Application No. 63/457,310, which is hereby incorporated herein by reference in its entirety.

### STATEMENT REGARDING FEDERALLY SPONSORED RESEARCH

This invention was made with government support under Award Number 7025826 awarded by the National Institute of Food and Agriculture. The government has certain rights in the invention.

### TECHNICAL FIELD

This disclosure relates to predicting characteristics of animals, and in particular to predicting dry matter intake of animals.

### BACKGROUND

Several technologies aid in monitoring animals, and cattle in particular. These technologies can provide information such as feed consumption, feeding behavior, animal activity, etc. For example radio frequency identification (RFIDs) and or cameras can be used to monitor consumption by animals, while other techniques can be used to measure other aspects of the animals such as average weight gain.

### SUMMARY

In accordance with the purpose(s) of the disclosure, as embodied and broadly described herein, the disclosure, in one aspect, relates to a computer-implemented system or method that can train a machine learning model for determining dry matter intake by animals. This can include receiving data comprising values of a set of variables corresponding to a plurality of animals, the set of the variables comprising at least water intake and dry matter intake; training a machine learning model on the data to provide values of dry matter intake based at least in part on the values of the set of the variables corresponding to the plurality of animals; after training, providing the machine learning model with input values for at least a subset of the variables associated with at least one animal to generate a predicted value of the dry matter intake for the at least one animal, wherein the input values comprise at least water intake values.

In further accordance with the disclosure, the machine learning model can include a random forest regression (RFR) model. In further accordance with the disclosure, training the RFR model can include: drawing ntree bootstrap samples randomly from the data; for each of the boostrap samples, generating a regression tree, where at each node of the tree, randomly sampling miry variables of the set of the variables and selecting a best split from the miry variables; and wherein predicting the value of dry matter intake includes aggregating predictions of the ntree trees. In further accordance with the disclosure, the machine learning model can include a repeated measures random forest (RMRF) model. In further accordance with the disclosure, training the RMRF model can include drawing ntree samples based on animal identifiers; for each of the samples, generating a regression tree, wherein at each node of the tree, randomly sampling mtry variables of the set of the variables and selecting a best split from the mtry variables; and predicting the value of dry matter intake by also aggregating predictions of the ntree trees.

In further accordance with the disclosure, the machine learning model can include repeated measures analysis of variance (RM ANOVA) model. In further accordance with the disclosure, the set of the variables further include a class of animal, body weight, age, average daily gain, and duration of in-pen weighing episodes. In further accordance with the disclosure, the set of the variables further include test day, minimal daily temperature, maximal daily temperature, minimum daily relative humidity, maximal daily humidity, average daily humidity, wind speed, maximum daily wind speed, average daily wind speed, W-wave radiation, and daily total precipitation.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE DRAWINGS

FIG. 1 shows a networked environment that includes components that perform dry matter intake prediction.

FIG. 2 shows a flow diagram of an example process for training and inference of a machine learning model.

FIG. 3 shows a schematic of an example random forest regression (RFR) model that can be utilized as the machine learning model discussed above in relation to the dry matter intake process shown in FIG. 2.

FIG. 4 shows a schematic depicting the importance of variables based on RFR and repeated measure random forest (RMRF) models.

FIG. 5A shows plots of measured and predicted dry matter intake from each of the RFR, RMRF, and repeated measures analysis of variance (RM ANOVA) models.

FIG. 5B shows plots of measured and predicted dry matter intake by averaging the actual and predicted dry matter intake from the full model across all testing days and each animal being represented by one datapoint.

FIG. 6 shows an example on-side measurement device that can be utilized for dry matter intake prediction.

FIG. 7 shows a block diagram of an example computing system that can be utilized for dry matter intake prediction.

Like reference numbers and designations in the various drawings indicate like elements.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used in the specification and the appended claims, the singular forms “a,” “an” and “the” include plural referents unless the context clearly dictates otherwise. Thus, for example, reference to “a proton beam degrader,” “a degrader foil,” or “a conduit,” includes, but is not limited to, two or more such proton beam degraders, degrader foils, or conduits, and the like.

The various concepts introduced above and discussed in greater detail below may be implemented in any of numerous ways, as the described concepts are not limited to any particular manner of implementation. Examples of specific implementations and applications are provided primarily for illustrative purposes.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

Traditional approaches have developed models to predict intakes of beef cattle. However, many of these models lack precision and consistently suffered from issues with overprediction of intakes of livestock. Additionally, no models used to predict dry matter intake can be employed to predict dry matter intake of individual beef cattle, leaving characterization of feed intake traits to be assigned to groups of animals, regardless of the actual, highly-varied animal intakes within the group. Use of machine learning in agricultural technologies and research has increased, however much of ML's use in agriculture is relegated to cropping systems. Those ML-based predictive models designed for animal agriculture are widely used in animal welfare, genomics, and prediction of body weight. Measuring individual animal feed intake in non-confined pasture settings can be challenging as it may need collection and analysis of foraging behaviors, forage intake, and forage quality. Given that the majority of beef cattle, including the cow herd, are maintained in a non-confined pasture setting, predicting dry matter intake using proxies and mathematical modeling may allow for implementation of management strategies based on animal intake and provide estimates of animal efficiency. While a model derived from confined settings may be not perfectly predict pasture setting dry matter intake, the models nevertheless can provide some level of prediction of dry matter intake in pasture settings.

As discussed herein, the use of machine learning models allows for close prediction of beef cattle dry matter intake at the scale of the individual animal. Data representing animals fed in confinement can be provided to the machine learning models to train the models. The trained models presented herein predict the dry matter intake in in confinement with high degree or accuracy, indicating that such models can be of use in also predicting dry matter intake for non-confined animals.

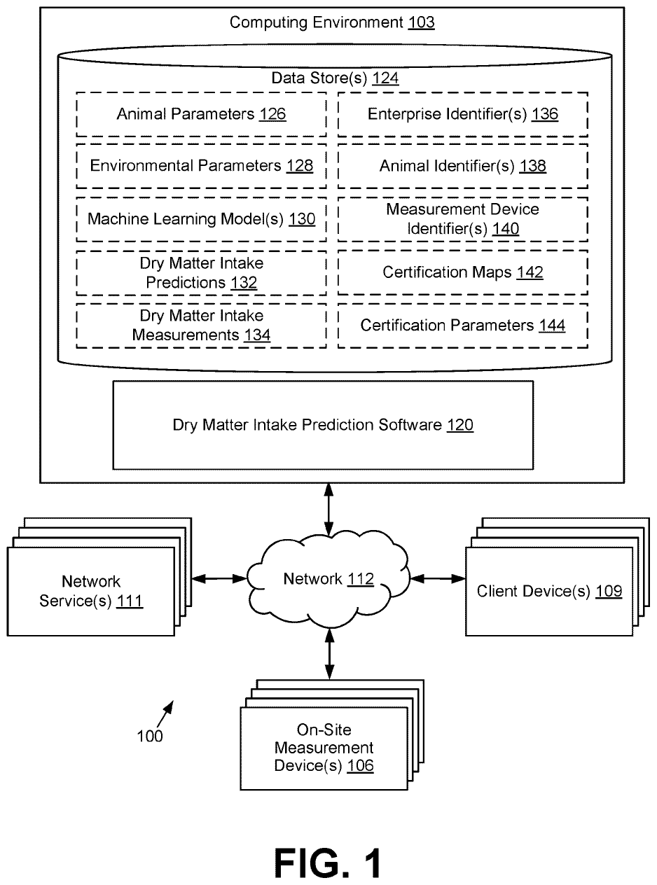

FIG. 1 shows a networked environment 100 that includes components that perform dry matter intake prediction. The networked environment 100 can include a computing environment 103, client devices 109, and network services 111, which can be in data communication with each other via a network 112.

The computing environment 103 can include one or more computing devices that can respectively include a processor, a memory, and/or a network interface. For example, a computing environment 103 can be configured to perform computations on behalf of other computing devices or computing systems. As another example, such computing devices can host and/or provide content to other computing devices in response to requests for content. There may be one or more central processing units, graphics processing units, tensor processing units, or other similar processors and coprocessors. Moreover, the computing environment 103 can refer to a plurality of computing devices that can be arranged in one or more server banks or computer banks or clusters or other arrangements. Such computing devices can be located in a single installation or can be distributed among many different geographical locations. For example, the computing environment 103 can include a plurality of computing devices that together can include a hosted computing resource, a grid computing resource, a container cluster, or any other distributed computing arrangement. In some cases, the computing environment 103 can correspond to an elastic computing resource where the allotted capacity of processing, network, storage, or other computing-related resources can vary over time. The computing environment 103 can execute instructions including dry matter intake prediction software 120, among other executable instructions including hypervisors, operating systems, applications, drivers, services, and so on.

The client device 109 is representative of a plurality of client devices 109 that can be coupled to the network 112. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, medical equipment or other devices with like capability. The client device 109 can support speech-based applications. The client device 109 can include one or more displays such as liquid crystal displays (LCDs), gas plasma-based flat panel displays, organic light emitting diode (OLED) displays, electrophoretic ink (“E-ink”) displays, projectors, or other types of display devices. In some instances, the displays can be a component of the client device 109 or can be connected to the client device 109 through a wired or wireless connection.

The client device 109 can be configured to execute various applications such as a client application or other applications. The applications can transmit, receive, and otherwise communicate data to enable and access functionalities of the dry matter intake prediction software 120. The client application can be executed in a client device 109 to access network content served up by the computing device(s) 103 or servers, thereby rendering a user interface on a display of the device. To this end, the client application can include a browser, a dedicated application, or other executable, and the user interface can include a network page, an application screen, or other user mechanism for obtaining user input. The client device 109 can be configured to execute client applications such as browser applications, chat applications, messaging applications, email applications, social networking applications, question-answering applications, word processors, spreadsheets, or other applications.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks. Examples of networks can include the Internet, intranets, extranets, virtual private networks (VPNs), and similar networks.

Various data is stored in a datastore 124 that is accessible to the computing environment 103. The datastore 124 can be representative of a plurality of datastores 124, which can include relational databases or non-relational databases such as object-oriented databases, hierarchical databases, hash tables or similar key-value datastores, as well as other data storage applications or data structures. Moreover, combinations of these databases, data storage applications, and/or data structures can be used together to provide a single, logical, datastore. The data stored in the datastore 124 is associated with the operation of the various applications or functional entities described below. The data stored in the datastore 124 can include animal parameters 126, environmental parameters 128, machine learning models 130, dry matter intake predictions 132, dry matter intake measurements 134, enterprise identifiers 136, animal identifiers 138, animal type identifiers 140, certification data 142, and certification parameters 144, among other items which can include executable and non-executable data. The data that is stored in a datastore 124 can include the dry matter intake prediction software 120, and other executable instructions as discussed.

The animal parameters 126 can include parameters that are measured using an on-site measurement device 106 and transmitted or otherwise transferred to the computing environment 103, which receives this data. The animal parameters 126 can include parameters that are entered or selected by user interactions with a user interface generated using the dry matter intake prediction software 120.

The animal parameters 126 can include static parameters that are associated with an animal type but are not subject to regular change, as well as dynamic parameters such as weight, water intake, dry matter intake measurements 134, and other information. The dynamic parameters can have timestamped values that can be received and updated periodically, on a schedule, on demand, or otherwise upon receipt of updated information. In some examples, the static parameters can include non-timestamped or untimestamped values.

The animal parameters 126 can include physiological data for the animals. For example, the data can include the type, breed, sex, a unique animal type identifier and other information of the animals such as the farm from which the animals were sourced, the weight of the animals, and the methodology used for tagging and weighing the animals. In some instances, where the prediction for dry matter intake is to be carried out on bovine animals, the data can include whether the animals were bulls or steers, the breed (e.g., Angus, Hereford, Charolais, Simmental, SimAngus, etc.), and so on. As one example, the animal parameters 126 can indicate include 153 bovines of which 126 are Angus, 11 are Hereford, 3 are Charolais, 3 are Simmental, and 10 are SimAngus. The animal parameters 126 can indicate that the animals are ear tagged per test guidelines such as, for example, the Wardensville Bull Test Guidelines.

The animal parameters 126 can include intake data associated with the animals. In instances where automated technology of an on-site measuring device 106 can be utilized for measuring various intake variables or values. For example, feed intake nodes such as, for example, on-site measuring device 106 can include a GrowSafe® systems device, can be used to collect feed intake data. With regards to weight, on-site measuring device 106 can include In-Pen Weighing (IPW) to weigh the animals daily or at another frequency. In some examples, water intake can be measured using an on-site measuring device 106 that includes custom flow meters, and the water can be provided to the animals as the animals access the IPW positions of the on-site measuring device 106 or devices. The feed intake can be measured using on-site measuring device 106 feed stations. The animal feed can be provided with specific weight gain in mind. For example, the animals can be fed as a function of a target average daily gain (ADG) in weight. In some examples, multiple on-site measuring devices 106 of different types can be used in the environment. For example, one type of on-site measuring device 106 can measure weight and water intake, while another type of on-site measuring device 106 can measure feed intake, and another type of on-site measuring device 106 can measure all or a subset of environmental parameters 128. In other examples, an on-site measuring device 106 can measure weight and water intake as well as all or a subset of environmental parameters 128. A particular type of on-site measuring device 106 can measure one or more animal parameters 126 as well as one or more environmental parameters 128.

The environmental parameters 128 can include parameters that are measured using an on-site measurement device 106 and transmitted or otherwise transferred to the computing environment 103, which receives this data. The environmental parameters 128 can include parameters that are entered or selected by user interactions with a user interface generated using the dry matter intake prediction software 120. The environmental parameters 128 can include parameters that are transmitted or otherwise transferred from the network services 111 to the computing environment 103, which receives this data. The environmental parameters 128 can include static parameters that are not subject to regular change, as well as dynamic parameters that can be updated regularly. The dynamic parameters can have timestamped values that can be received and updated periodically, on a schedule, on demand, or otherwise upon receipt of updated information. In some examples, the static parameters can include non-timestamped or untimestamped values.

The environmental parameters 128 can include climate data. For example, various weather sensors such as a climate station of an on-site measuring device 106 or another device can be positioned in proximity to the animals to record values of climate related variables. A Global Positioning System (GPS) location or other location data can also be used to retrieve environmental parameters 128 from a network service 111 that identifies and transmits environmental parameters 128 in association with locations.

Additionally or alternatively, climate data can be identified by determining a geographically closest publicly (or privately) available climate data source (e.g., weather station) and retrieving publicly available data for the geographically closest climate data source such as a National Oceanic and Atmospheric Administration weather station over a network.

In some examples, variables such as temperature, humidity, precipitation levels, wind speed, net radiation, etc. can be measured over time and can be stored as environmental parameters 128. The environmental parameters 128 can also include a type of dry matter than is used as feed. The environmental parameters 128 can also include types of plants that are in an area where the animals are kept, including edible plants, inedible plants, shade plants, and so on. The environmental parameters 128 can also indicate whether solar panels are used in an area where the animals are kept, whether shade is available, an amount of the area that is covered with solar panels, shade, or any other factor present or affecting the area.

The dry matter intake prediction software 120 can generate a user interface through which a user can enter any arbitrary item or parameter, as well as an amount or measure of the item or parameter. The dry matter intake prediction software 120 can generate a user interface through which a user can select parameters previously entered by other users, for example, from other enterprises corresponding to other enterprise identifiers 136. The dry matter intake prediction software 120 can identify whether the dry matter intake measurements 134, water intake, weight, and other animal parameters 126 that are used for training the machine learning models 130 are affected by the presence of any of the environmental parameters 128, including user-entered arbitrary parameters that may be of interest to users of various enterprises. This can identify previously unknown correlations that can be a benefit or a detriment to animal growth.

The machine learning models 130 can include a random forest regression (RFR) model, the repeated measures random forest (RMRF) model, or the repeated measures analysis of variance (RM ANOVA) model. However, these are only a few examples, and other models can also be utilized, such as Support Vector Machines (SVM), neural networks, deep learning, and so on. The dry matter intake prediction software 120 can train the machine learning models 130 using the animal parameters 126, the environmental parameters 128, and the dry matter intake measurements 134 to generate dry matter intake predictions 132 based on inputs that include any subset of the animal parameters 126 and the environmental parameters 128, for example, animal type, animal weight, and animal water intake (or any other group of variables corresponding the any subset of the animal parameters 126 and the environmental parameters 128). A training set of animal parameters 126, the environmental parameters 128, and the dry matter intake measurements 134 can be used to train the machine learning models 130, where the dry matter intake measurements 134 are used as a ground truth as a verified parameter correlated with variables including the set of animal parameters 126 and the environmental parameters 128. In some examples, predictions can be further trained using feedback such as dry matter intake measurements 134. The machine learning models 130 can use values of dry matter intake measurements 134 to verify whether values of the dry matter intake predictions 132 are correct, as an iterative feedback training mechanism.

The dry matter intake predictions 132 can refer to the outputs from the machine learning models 130. A dry matter intake prediction 132 can include an amount of dry matter feed indicated for a particular time period, and the time period can be projected for a particular date. A projected dry matter intake prediction 132 for a date corresponding to one amount of time in the future can be different from another projected dry matter intake prediction 132 for a date corresponding to another amount of time in the future. As a result, the machine learning model 130 can generate a dry matter intake prediction 132 and transmit it to a user that can then make an order or request for the dry matter. For example, if a user regularly requests dry matter from a supplier on every other Tuesday, on every Friday, or on a particular day each month, the dry matter intake prediction software 120 can include a user interface element that enables a user to enter or select the regular request timing information. The dry matter intake prediction software 120 can then use the request timing information, as an input to generate projected dry matter intake prediction 132 periodically corresponding to the request timing information. For example, the amount of dry matter can be an amount corresponding to an amount of time between requests, and the projected date can be a date corresponding a request date according to the request timing information. In some examples, this dry matter intake prediction 132 can be provided the day before a request date or on the request date, but in other examples, the dry matter intake prediction 132 can be provided multiple days before a request date. In some examples, the dry matter intake prediction 132 can be provided multiple times on different days, and the dry matter intake prediction software 120 can use the most-recent set of values for the various parameters as inputs for the machine learning model 130.

The dry matter intake prediction software 120 can use the machine learning model 130 to generate dry matter intake prediction 132 based on inputs of variables corresponding to values for any subset of the animal parameters 126 and the environmental parameters 128 (for example, for a particular animal or group of animals, and for at least one day or more) the machine learning model 130 can generate an amount of dry matter feed (for example, for the particular animal or the group of animals) for a predetermined time period such as the next day, the next week, the next month, or another time period. Multiple time periods can be projected based on an input that includes values for animal parameters 126 and environmental parameters 128 corresponding to one day (or values for multiple days). In some examples, the dry matter intake prediction software 120 can generate a user interface element that enables a user to select or enter a type of dry matter, and the dry matter intake predictions 132 can indicate a type of dry matter.

The dry matter intake measurements 134 can refer to actual measured values for dry matter provided to an animal or group of animals for a particular amount of time. In some examples, a particular amount of dry matter can be provided, and then after the amount of time (such as a day) the dry matter can be measured, and the difference can indicate the value of the dry matter intake measurement 134 for that time period.

The enterprise identifiers 136 can refer to unique identifiers that uniquely identify an enterprise such as a farm, a farmer, a university, a corporation, or another entity that manages and raises the animals, among a plurality of enterprises that use the dry matter intake prediction software. The enterprise identifiers 136 can be associated with a particular location and a set of environmental parameters 128 (including one or more corresponding values over time as can be understood). In instance in which the enterprise includes multiple locations where animals are raised, then multiple location identifiers can be associated with the enterprise identifier 136, and each location identifier can be associated with a set of environmental parameters 128 and values thereof.

The animal identifiers 138 can refer to unique identifiers that uniquely identify particular animal or group of animals among a plurality of particular animals and groups of animals. An animal identifier 138 can be associated with a set of animal parameters 126 (including one or more corresponding values over time as can be understood). An animal identifier 138 can be associated with one or more animal parameters 126 which can include animal types and animal subtypes such as bovine, breed of bovine, and class such as steer, bull, cow, and so on. An animal identifier 138 can be associated with an enterprise identifier 136 of an enterprise that owns or manages that animal, as well as a location identifier if applicable. As a result, an animal can also be associated with the set of environmental parameters 128. The dry matter prediction software 120 can map an animal identifier 138 to a set of animal parameters 126 and a set of environmental parameters 128. The dry matter prediction software 120 can map an enterprise identifier 136 or a location identifier to a set of animal identifiers 138.

A measurement device identifier 140 can refer to unique identifiers that uniquely identify an on-site measurement device 106 among a plurality of on-site measurement devices 106. A measurement device identifier 140 can be associated with a particular animal identifier 138 indicating that it measures values for a particular animal or group of animals. The dry matter prediction software 120 can map the location to a subset of the environmental parameters 128. The on-site measurement device 106 can also measure one or more of the environmental parameters 128 and the animal parameters 126. The on-site measurement device 106 can transmit this data to a cloud-based version of the dry matter prediction software 120 in association with its measurement device identifier 140, as well as the associated enterprise identifier 136, location identifier, and animal identifier 138. As a result, the dry matter prediction software 120 can store the measured environmental parameters 128 and animal parameters 126 from the on-site measurement device 106 in association with these identifiers in order to retrieve appropriate parameters for predictions. The on-site measurement device 106 can additionally or alternatively execute a local version of the dry matter prediction software 120 and perform dry matter prediction locally.

The certification maps 142 can include information that enables the dry matter prediction software 120 to generate certification parameters 144 using the environmental parameters 128 and animal parameters 126 (which can include the dry matter intake measurements 134 in some examples). The certification parameters 144 can refer to metrics or parameters indicating whether an animal, group of animals, an enterprise, or a location identified using corresponding identifiers, qualifies for a predetermined certification such as an environmentally friendly certification. The certification parameters 144 can refer to parameters that indicate the animal, group of animals, enterprise, or location has a carbon footprint according to a predetermined metric. For example, for every predetermined amount (e.g., 1 kilogram) of dry matter intake consumed, animals can generate a predetermined amount (e.g., 23 grams) of methane, according to the certification maps 142. This can provide an estimate of methane output and a certification parameters 144. The methane output can be combined with dry matter intake, water intake, and other values to identify certain certification parameters 144 such as methane efficiencies relative to dry matter intake and water intake.

An on-site measurement device 106 can include a permanent fixture, a semi-permanent device, or a temporarily located device. In some examples, a set of on-site measurement devices 106 can be provided, such that each on-site measurement device 106 is registered to a single animal (to identify animal-specific values) or a group of animals (to identify aggregated values), according to animal identifiers 138 for the animal or group of animals.

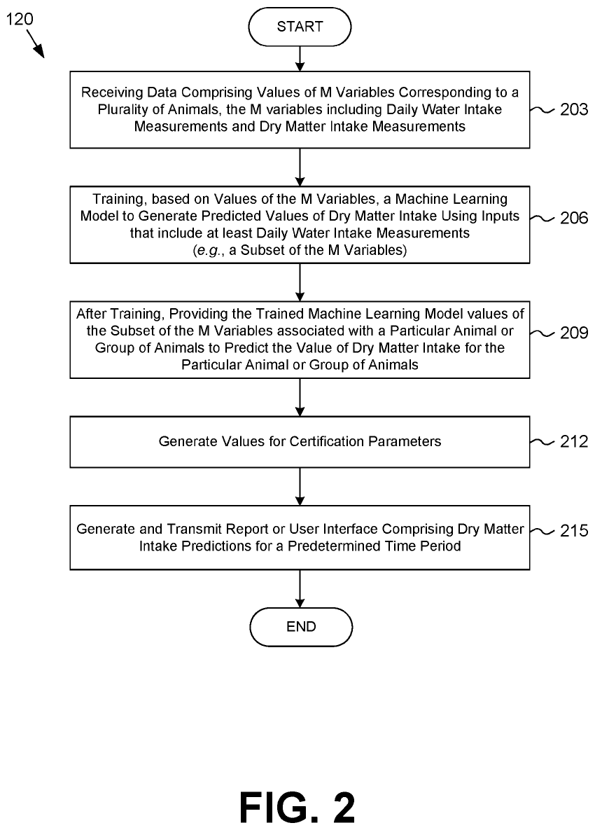

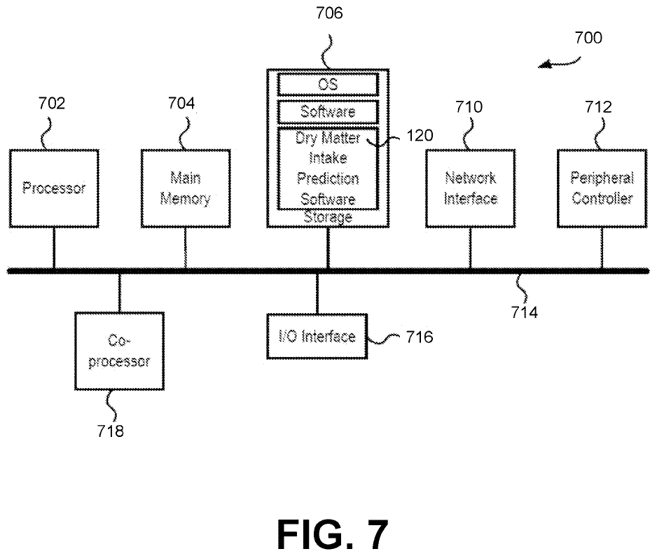

FIG. 2 shows a flow diagram of the dry matter intake prediction software 120 performing training and inference using a machine learning model 130. Specifically, the dry matter intake prediction software 120 can receive relevant data, train a machine learning model 130 based on the data to determine values of dry matter intake, and provide values of dry matter intake predictions 132 based on input values for animal parameters 126 and environmental parameters 128. The dry matter intake prediction software 120 can be executed by a processor and/or the co-processor (see FIG. 7).

In box 203, the dry matter intake prediction software 120 includes receiving data comprising values of M variables corresponding to a plurality of animals, where the M variables include at least the variables of water intake and dry matter intake associated with the plurality of animals. The data received can be stored for example in the non-transitory memory storage of a computing system of the computing environment 103. In some instances, the data can be at least partially stored in a main memory for processing by a processor. The data can be received by the computing environment 103 via an external storage system, such as a hard drive, optical drive, flash drive, etc., via an I/O interface, or can be received from one or more networked devices including the network service 111, the on-site measurement devices 106, and the client devices 109 via a network interface of the network 112.

The data can include animal intake and physiological data as well as climate data. For example, the data can include one or more of the animal parameters 126 as well as the environmental parameters 128 as discussed. As an example set of variables, the M variables can include class (e.g., bull or steer), weight, age, average daily gain, water intake, duration of IPW episodes, frequency of IPW episodes, test day, minimal daily air temperature, maximal daily air temperature, average daily temperature, minimum daily relative humidity, maximum daily relative humidity, average daily relative humidity, minimum wind speed, maximum wind speed, average daily wind speed, W-wave radiation, total precipitation, and dry matter intake. These set of variables are only examples, and the M variables can include a subset of these variables or include additional animal parameters 126 and environmental parameters 128.

Hundreds of values of the subset or the entirety of the M variables can be determined over time. In some examples, more than a thousand observations can be recorded, where each observation includes the values of the subset or the entirety of the M variables. Typically, the observation data can be arranged in a data structure such as, for example, a table that includes as columns the names of the variables, and can include as rows various observed values of the variables.

In box 206, the dry matter intake prediction software 120 can include training a machine learning model 130 on the data to provide values of dry matter intake based on the values of the M variables. In particular, the dry matter intake prediction software 120 can include training the machine learning model 130 based on a subset of the M variables or the entirety of the M variables. The training can train the machine learning model 130 to take a particular subset (or any subset) of the M variables as inputs even if a more-inclusive set of the M variables are used for training. In various examples, the subset of the M variables used for training may or may not include environmental parameters 128 as variables. The machine learning model 130 can be trained to determine a value of the dry matter intake based on input values of a subset or the entirety of the M variables. In some instances, the subset of M variables can include the water intake variable. In some instances, the subset of M variables can include the water intake variable and the animal weight variable. The machine learning model 130 can use inputs including a plurality of values over time for each of the animal parameters 126 and environmental parameters 128. In other examples the machine learning model 130 can use inputs including the most-recent values for the animal parameters 126 and environmental parameters 128.

The machine learning model 130 can include, for example, a random forest regression (RFR) model, the repeated measures random forest (RMRF) model, or the repeated measures analysis of variance (RM ANOVA) model. However, these are only a few examples, and other models can also be utilized.

Training the machine learning model 130 can include providing the subset of or the entirety of M variables to the model to predict the value of the dry matter intake. In some instances, the models can be statistical models that can use statistical methods to learn from the M variables to find patterns in the data to predict the value of the dry matter intake. The statistical machine learning model 130 can include, for example, decision trees, or ensemble algorithms such as the RFR and RMRF models mentioned above.

In box 209, the dry matter intake prediction software 120 can provide the trained version of the machine learning model 130 with inputs including current values of a subset of the animal parameters 126 and environmental parameters 128 (for example, all or a subset of those used for training). The dynamic or regularly updated animal parameters 126 can include water intake and animal weight, which can refer to individual animals and/or aggregated for all animals in a pen, paddock, field, or other area. However, any number of the animal parameters 126 and environmental parameters 128 can be provided as inputs. The inputs can also include other arguments such as a date to predict for, a period of time the dry matter is to be used, and other parameters as discussed herein. The trained version of the machine learning model 130 can generate one or more dry matter intake predictions 132 based on the input arguments provided.

In box 212, the dry matter intake prediction software 120 can generate values for certification parameters 144. In some examples, the trained version of the machine learning model 130 can also generate the certification parameters 144. The dry matter intake prediction software 120 (and/or the machine learning model 130) can use the certification maps 142 to map the animal parameters 126 and environmental parameters 128 to values for certification parameters 144. In some examples, the certification maps 142 and certification parameters 144 can be provided as training values and input arguments for the machine learning model 130.

In box 215, the dry matter intake prediction software 120 can generate a report and/or a user interface that shows the dry matter intake predictions 132 for the predetermined time period. The report and/or the user interface can also show the certification parameters 144. The dry matter intake prediction software 120 can transmit a notification such as a short message service message, an email message, an electronic message, or another message that includes a file that encodes the report, or a hyperlink to access the user interface.

The report can also include a feed efficiency for an individual animal and/or a group of animals. The feed efficiency can refer to an amount of dry matter intake per pound (or other measure) of weight gain for a particular time period. The input values used for the prediction can include updated water intake and weight, and the amount of dry matter provided is known (users and enterprises generally feed dry matter such that there is no leftover dry matter, and the dry matter provided is a known input for the system). In some examples, the dry matter intake prediction software 120 and the machine learning model 130 can use a previous dry matter intake prediction for the immediately preceding time period for the dry matter provided value. As a result, the dry matter intake prediction software 120 and/or the machine learning model 130 can generate feed efficiency based on the previous dry matter predictions and the measured weight values for the animal or group of animals. In some examples, the dry matter intake prediction software 120 can identify a list of a set of animals (or a listing of a set of groups of animals) that correspond to a top 5, 10, or other number (or percent) of animals or groups with the highest feed efficiencies. This listing of highest feed efficiency can be provided in the report and/or user interface.

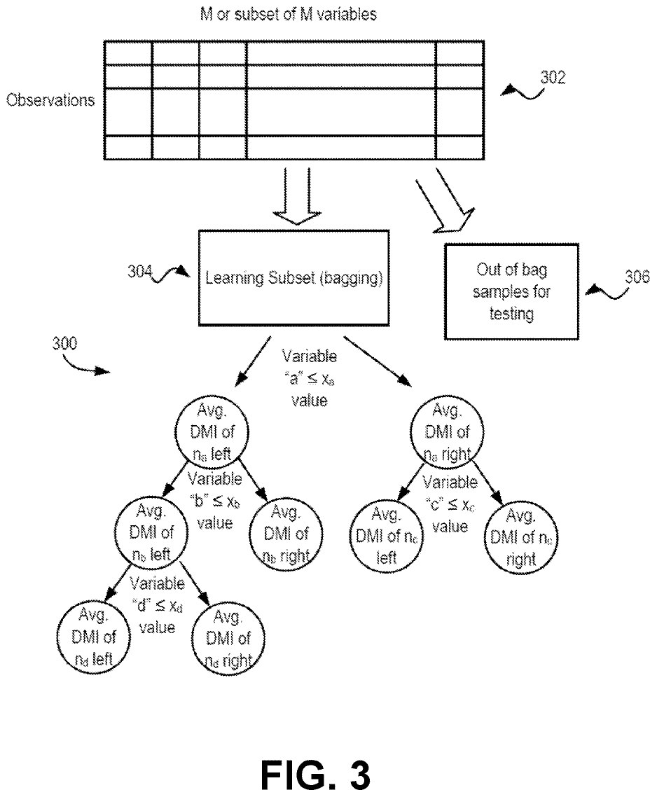

FIG. 3 shows a schematic of an example RFR model 300, according to some examples where the machine learning model 130 can include the RFR model 300. The RFR model 300 can be utilized as the machine learning model 130 discussed above in relation to the dry matter intake prediction software 120 shown in FIGS. 1 and 2. The RFR model, as mentioned above, is an example of an ensemble model, in which results of multiple decision trees is aggregated to predict the outcome. In particular, multiple decision trees of the RFR model 300 can each make a prediction of the value of the dry matter intake. The final outcome of the prediction of the dry matter intake can be determined as an aggregate of the predicted values of the multiple decision trees of the RFR model 300.

The dry matter intake prediction software 120 when training the RFR model 300 can begin with considering the training data that includes a subset of or the entirety of the M variables of animal parameters 126 and environmental parameters 128. The data can be denoted, for example, by the data structure 302, which includes multiple columns corresponding to the multiple variables and multiple rows corresponding to the multiple samples or observations, each of which includes the values of the variables in the columns. The dry matter intake prediction software 120 can draw ntree bootstrap samples randomly from the data. Each of the ntree bootstrap samples can include a subset of the observations. For example, the dry matter intake prediction software 120 can select a subset of the rows of the data structure 302 as one ntree sample. The dry matter intake prediction software 120 can randomly select another subset of the rows of the data structure 302, with replacement, to form another ntree sample. The dry matter intake prediction software 120 can repeat these steps until a predetermined number of the rows are included in a learning subset 304. This sub-process can be denoted as bootstrap aggregating (bagging), where the bootstrap aggregated (bag, bagged) ntree samples can be used for training. The remainder of the observations or rows can be denoted as out of the bag samples 306 and can be used for testing the model. As an example, the learning subset 304 can include about 70% of the observations while the out of the bag samples can include about 30% of the total observations. The 70%-30% split are only examples, and other proportions could also be achieved.

The dry matter intake prediction software 120 can generate a regression tree or a decision tree for each of the ntree samples. For each decision tree, the dry matter intake prediction software 120 can sample or select mtry number of variables from the M variables and select the best variable from the miry variable to split the tree. In some examples, a third of the M variables can be tested at each node of the decision tree. The dry matter intake prediction software 120 can split the learning subset 304 into two groups based on the smallest mean square error (MSE) of bivariate fits, growing the decision tree and repeating the process until a terminal node is reached.

Once the RFR model is generated, the bag samples 306 can be used to test the RFR model. Each row of observations can be fed to the ntree decision trees, each of which can predict a value of the dry matter intake. The ntree precited values of the ntree decision trees can be aggregated to arrive at the final predicted value. This predicted value can be compared to the recorded value of the dry matter intake, to determine the accuracy of the model.

In some examples, the machine learning model 130 can be a RMRF model. This model is similar to the RFR model discussed above in relation to FIG. 3. The difference is in how the bagging of the ntree samples is carried out. In RFR the bagging is based on a random sample of all observations. In contrast, in RMRF, the bagging is based on the animal identifiers. This can allow for better control of inner correlations within the animal. The prediction for the dry matter intake can be determined in the same manner as in RFR, i.e., taking the aggregate of the prediction values of the ntree decision trees.

In some examples, the machine learning model 130 can be a RM ANOVA model. The dry matter intake prediction software 120, for the RM ANOVA model, can first select a suitable covariance structure (autoregressive of the first degree) for the within-subject (within animal) model. Then the entire model can be fit using the autoregressive covariance structure in a marginal probability model. The dry matter intake prediction software 120 can select time (e.g., the test day) as the repeated factor and select the animal identifier as the subject. The dry matter intake prediction software 120 can also select the random effects as climate variables (e.g., temperature, humidity, wind speed, W-wave radiation, precipitation, etc.).

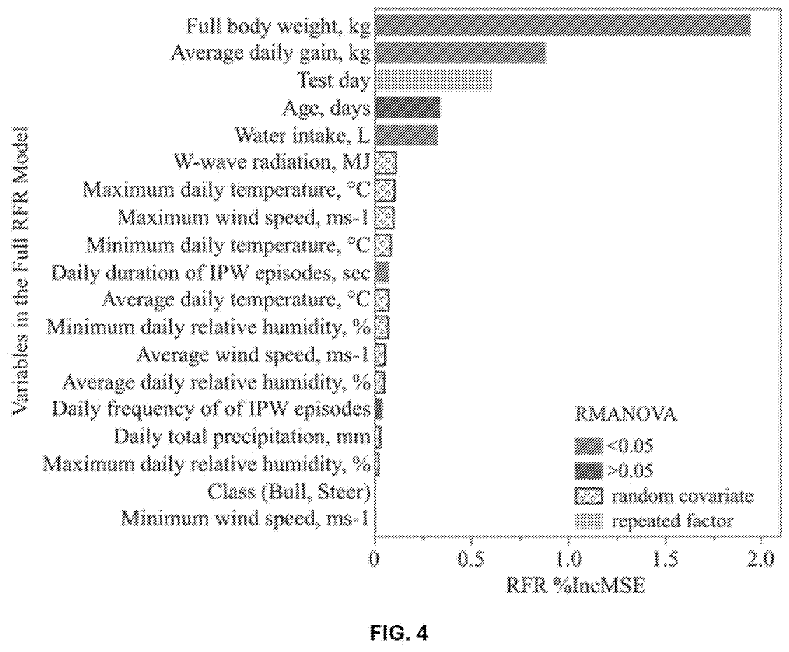

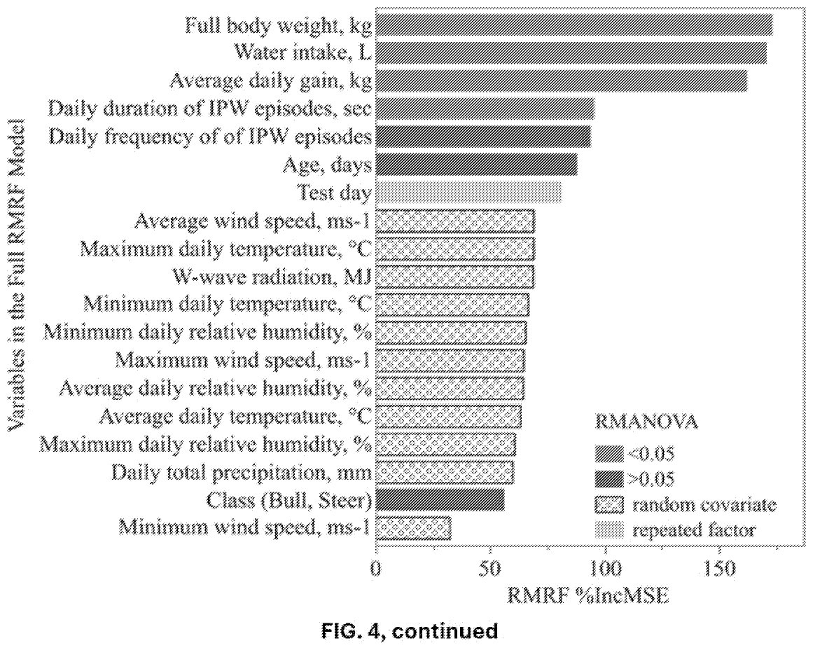

FIG. 4 shows a schematic depicting the importance of variables based on RFR and RMRF. In particular, FIG. 4 shows a ranked importance, from strongest to weakest predictor, of variables in predicting the dry matter intake. The data shown in FIG. 4 can be based on a full model RFR and RMRF, i.e., both animal related and climate related variables were considered in training the model. The “importance” of a variable can refer to the variable with the highest percentage increase in the mean square error (% increase MSE) when that variable was no included in a given decision tree. As seen in FIG. 4, in both RFR and RMRF body weight, average daily gain, and water intake in addition to test day and age, were amongst the most influential variables with respect to predicting dry matter intake. FIG. 4 also demonstrates that RM ANOVA, based on the effect p-values, can have a similar ranking of the variable importance as the RF and RMRF models, with body weight, average daily gain, water intake, and duration of drinking significant in the RM ANOVA models that both did and did not consider climactic variables.

In one example, based on a specific set of data, the RM ANOVA prediction equation for the model that considers both the animal related and climate related variables can be expressed as:

$$DMI = 2.134 + 1.7128 \times ADG [ kg ] + 0.0346 \times Water Intake [ L ] + 0.0002 \times Duration of IPW episode [ s ] + 0.07022 \times Full BW [ kg ] + ( 0.18462 if animal was a steer or - 0.18462 if a bull$$

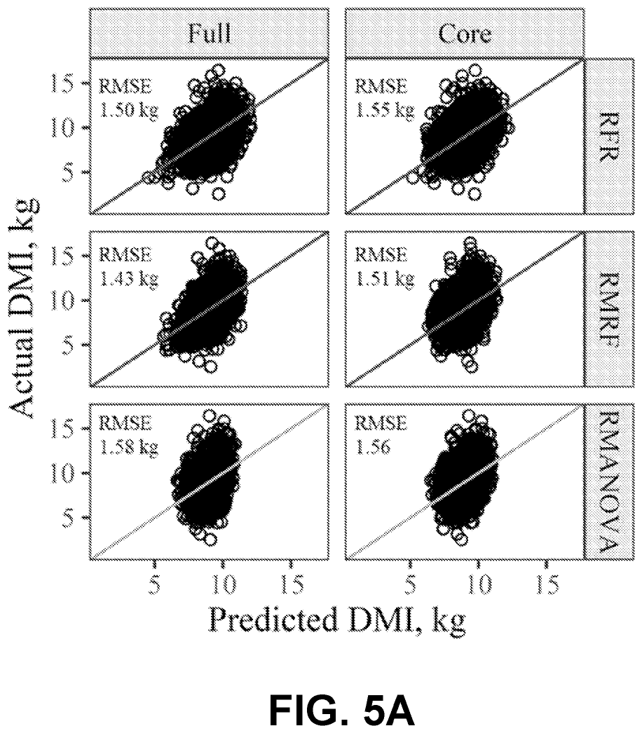

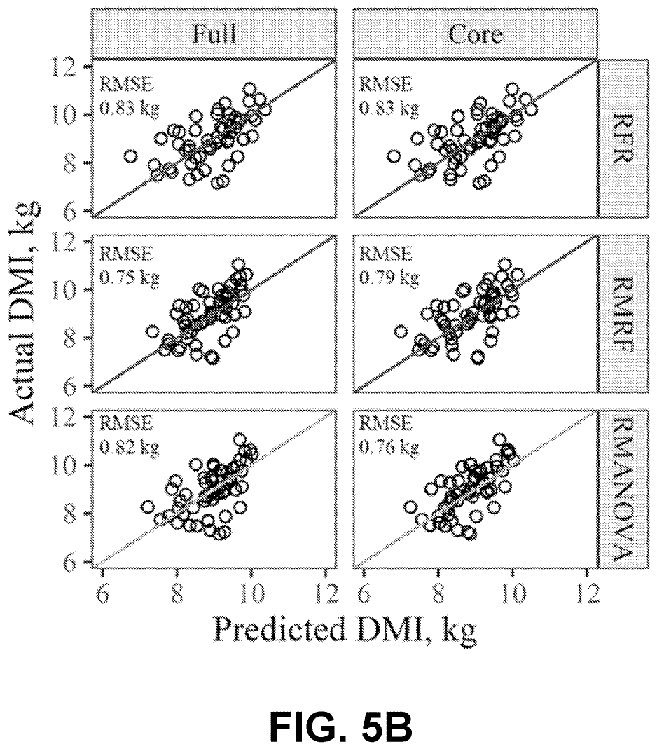

FIG. 5A shows plots of measured and predicted dry matter intake from each of the RFR, RMRF, and RM ANOVA models. The full model refers to a model that takes into consideration both the animal related variables and the climate related variables, while the core model refers to the model that takes into consideration the animal related variables but does not take into consideration the climate related variables. FIG. 5A demonstrates that in the full model, the predictions using the RMRF model had the smallest predicted error (root mean square error (RMSE) of 1.43 kg daily dry matter intake). In the core models, RFR and RMANOVA generated very similar errors of prediction (1.55 and 1.56 kg, respectively, of daily dry matter intake), with RMRF exhibiting the best RMSE (1.51 kg of daily dry matter intake). FIG. 5B shows plots of measured and predicted dry matter intake by averaging the actual and predicted dry matter intake from the full model across all testing days and each animal being represented by one datapoint. The RMSE for RM ANOVA was 0.82 kg, for FRF was 0.83 kg and for RMRF was 0.75 kg. For the core model, RM ANOVA had the smallest RMSE of 0.76 kg compared to that of RFR and RMFR (0.83 kg and 0.79 kg, respectively). In summary, the RFR and RMRF models had similar results to the mixed effects RM ANOVA when the same set of variables were used for all these models. For the full daily model including all climate related variables, the RMRF produced the smallest error of prediction, indicating that repeated component can be a superior approach when using random forests models. Use of the RMRF model allowed for the prediction of individual cattle dry matter intake across the test period within 0.75 kg RMSE of the actual dry matter intake.

Improvement of prediction accuracy could be attributed to the use of averages from the predictions based on the RMRF full model, all three models differed in their ranking of predictive variables. Full model RFR was able to predict individual cattle dry matter intake across the test period within 0.83 kg of the actual dry matter intake and ranked model variables in order of predictive importance as body weight, ADG, test day, age, and the water intake. Of those variables, only body weight, ADG and water intake were significant factors according to the RMANOVA model. Duration of IPW episodes was significant (P<0.05) but was ranked 10th in predictive performance by the RFR model. Full model RFR performance was lower when daily intake values were used instead of test mean values and allowed for prediction of dry matter intake within 1.5 kg RMSE of the actual dry matter intake. When using test mean values, performance of the RFR core model was identical to the full RFR (RMSE=0.83 kg). However, performance of the RFR full model was better compared to the RFR core model when daily intake values were used (RMSE=1.5 kg and 1.55 kg, respectively). However, improvements in prediction of 0.05 kg between full and core models may not be relevant given the advantage in reduced processing requirements of the core model.

Repeated Measures Random Forest generated accurate predictions of dry matter intake while accounting for the lack of independence of data within individual animal records. Reranking of importance of predictive variables occurred between RFR and RMRF models, but important variables remained largely the same between the two models. Notably, the predictive importance of water intake greatly increased in the RMRF model, with water intake and full body weight sharing nearly identical—and primary—predictive importance. Duration of drinking event also greatly increased in ranking of predictive importance between the RFR and RMRF models. Daily frequency of water visits and class (bull or steer) were ranked within the 10 most important variables but were not significant. Similar to the RFR model, the RMRF model differed in performance between both the full and core model and daily intake values and test mean values predictions. The test mean values generated from the full RMRF model provided the smallest error of all six models (RMSE=0.75 kg), with the core model performing marginally worse (RMSE=0.79 kg) than the full model. Performance of the RMRF was lower when using daily intake values, with the full and core models having RMSE's of 1.43 and 1.51 kg, respectively. It is unclear if the marginal improvement in model prediction is of higher value than the reduction in processing requirements allowed by use of the core model.

Of all the models, outputs of the RM ANOVA showed the most variation, with the RM ANOVA core model of the test means performing only marginally worse (RMSE=0.76 kg) than the RMRF full model on test means and the RM ANOVA full model using the daily intake values performing the poorest of all model iterations (RMSE=1.58). Unlike with RMRF, the core RM ANOVA models performed better than the full RM ANOVA models for both test means and daily intake values. The chief benefit of using RM ANOVA for prediction of dry matter intake is the development of an equation from which coefficients and relationships among variables can be elucidated.

References: All cited references, patent or literature, are incorporated by reference in their entirety. The examples disclosed herein are illustrative and not limiting in nature. Details disclosed with respect to the methods described herein included in one example or embodiment may be applied to other examples and embodiments. Any aspect of the present disclosure that has been described herein may be disclaimed, i.e., exclude from the claimed subject matter whether by proviso or otherwise.

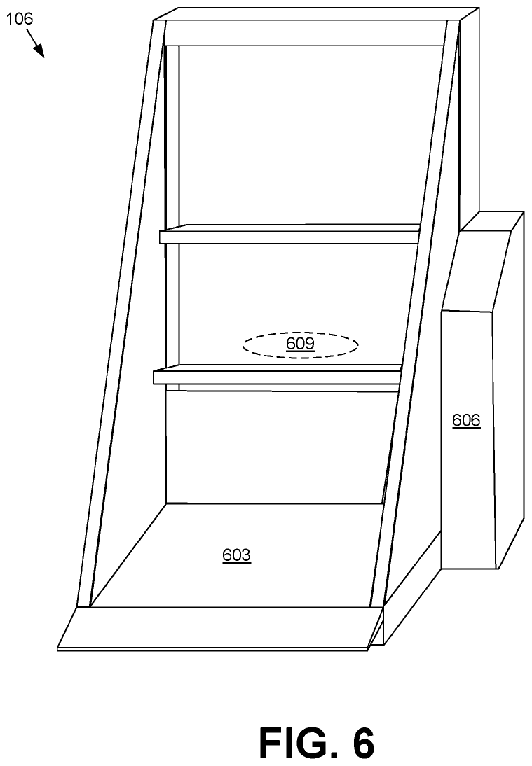

FIG. 6 shows an example of an on-site measurement device 106. Other types of on-site measurement devices 106 are also described herein. In this example, the on-site measurement device 106 can include a load sensor 603 or other weight/mass measurement device, a computing system housing 606 that includes a computing system (e.g., see FIG. 7), and an animal drinking area 609. The on-site measurement device 106 can be used to enable training of and use of the machine learning models 130 to generate dry matter intake predictions 132 as well as certification parameters 144.

While not shown, the on-site measurement device 106 can include a communicatively connected flow meter device or other water intake measuring device that the on-site measurement device 106 can use to identify water intake. The on-site measurement device 106 can include a structure that is designed so that the animal walks onto the load sensor 603 in order to drink water from a trough or basin in the animal drinking area 609, which is measured using the water intake measuring device. As the animal drinks, the load sensor 603 can measure animal weight.

In some examples, the on-site measurement device 106 can be designed to have a length such that the front two legs can be supported by the load sensor 603, while the rear two legs are supported by the ground. In that case the on-site measurement device 106 can calculate the total weight of the animal as the measured weight (applied to the load sensor 603 by the front two legs of the animal) multiplied by a predetermined multiplier associated with the animal type and/or other animal parameters 126.

Alternatively, the on-site measurement device 106 can be designed to be large enough so that the animal is fully supported by the load sensor 603 as the animal drinks from the animal drinking area 609.

The computing system housing 606 can include a computing device or system (see FIG. 7), which can execute dry matter intake prediction software 120 and/or an application that enables communication with a computing environment 103 that executes the dry matter intake prediction software 120. In some cases, the dry matter intake prediction software 120 can be considered a distributed application with components executed using the computing environment 103 as well as one or more on-site measurement devices 106 in communication over a network 112.

FIG. 7 shows a block diagram of an example computing system 700 that can be utilized for dry matter intake prediction. The computing system 700 can refer to one or more computing devices of the computing environment 103, the on-site measurement devices 106, or any combination thereof.

The computing system 700 can include a processor 702, a main memory 704, a non-transitory memory storage 706, a network interface 710, a peripheral controller 712, a communication bus 714, a I/O interface 716, and a co-processor 718. The processor 702 can include one or more central processing units, a microcontroller, a programmable logic controller, or any other programmable controller or processor. The main memory 704 can include volatile memory such as, for example, a random-access memory (RAM). The non-transitory memory storage 706 (also referred to as a “non-transitory computer readable storage medium”) can be a non-volatile memory storage such as, for example, a hard drive, a disk drive, a USB drive, a flash memory drive, etc. The non-transitory memory storage 706 can store software such as, for example, one or more operating systems, a dry matter intake prediction software 120, and other user software. The network interface 710 can allow communication with local and/or wide area networks. The peripheral controller 712 can communicate with peripheral devices such as, for example, keyboards, mice, display devices, and other such user devices. The I/O interface 716 can allow communication with other computing devices. The co-processor 718 can include processors or controller that can receive specialized processing tasks from the processor 702. For example, the co-processor 718 can include floating point units, graphics processing units (GPUs), etc. In some examples, the processor 702 can utilize the co-processor 718 to aid in executing machine learning models, neural network models or artificial intelligence models during training of the models or during inference.

The dry matter intake prediction software 120 can receive data to train a machine learning model 130 to predict dry matter intake. In particular, the dry matter intake prediction software 120 can predict the dry matter intake for a single animal based on data associated with the animal. The dry matter intake prediction software 120 can also predict the dry matter intake for a group of animals based on corresponding data aggregated for the group of animals. The dry matter intake prediction software 120 can include a distributed application that includes software applications and instructions executed on multiple devices in order to perform the dry matter intake prediction actions described herein, through the various figures. While aspects of the dry matter intake prediction can be described with respect to a particular figure, the actions can be logically combined with aspects of dry matter intake prediction described with respect to other figures.

The aspects of dry matter intake prediction can include, but are not limited to the following clauses. Clause 1 can describe computer-implemented method of training a machine learning model for determining dry matter intake by animals, comprising: receiving data comprising values of a set of variables corresponding to a plurality of animals, the set of the variables comprising at least water intake and dry matter intake; training a machine learning model on the data to provide values of dry matter intake based at least in part on the values of the set of the variables corresponding to the plurality of animals; after training, providing the machine learning model with input values for at least a subset of the variables associated with at least one animal to generate a predicted value of the dry matter intake for the at least one animal, wherein the input values comprise at least water intake values. Clause 2 can describe the computer-implemented method of clause 1, wherein the machine learning model includes a random forest regression (RFR) model. Clause 3 can describe the computer-implemented method of any one of clauses 1 or 2, wherein training the RFR model comprises: drawing ntree bootstrap samples randomly from the data; for each of the boostrap samples, generating a regression tree, wherein at each node of the tree, randomly sampling mtry variables of the set of the variables and selecting a best split from the miry variables; and wherein predicting the value of dry matter intake includes aggregating predictions of the ntree trees. Clause 4 can describe the computer-implemented method of any one of clauses 1-3, wherein the machine learning model includes a repeated measures random forest (RMRF) model. Clause 5 can describe the computer-implemented method of any one of clauses 1-4, wherein training the RMRF model comprises: drawing ntree samples based on animal identifiers; for each of the samples, generating a regression tree, wherein at each node of the tree, randomly sampling mtry variables of the set of the variables and selecting a best split from the mtry variables; and wherein predicting the value of dry matter intake includes aggregating predictions of the ntree trees. Clause 6 can describe the computer-implemented method of any one of clauses 1-5, wherein the machine learning model includes repeated measures analysis of variance (RM ANOVA) model. Clause 7 can describe the computer-implemented method of any one of clauses 1-6 wherein the set of the variables further include a class of animal, body weight, age, average daily gain, and duration of in-pen weighing episodes. Clause 8 can describe the computer-implemented method of any one of clauses 1-7, wherein the set of the variables further include test day, minimal daily temperature, maximal daily temperature, minimum daily relative humidity, maximal daily humidity, average daily humidity, wind speed, maximum daily wind speed, average daily wind speed, W-wave radiation, and daily total precipitation.

Clause 9 can describe a system, comprising: at least one computing device comprising at least one processor; and at least one memory comprising instructions executable using the at least one processor, wherein the instructions, when executed using the at least one processor, cause the at least one computing device to at least: receive data comprising training values of a set of variables corresponding to a plurality of animals, the set of the variables comprising at least water intake and dry matter intake; train a machine learning model on the data to generate values of dry matter intake based at least in part on the values of the set of the variables corresponding to the plurality of animals; provide a trained version of the machine learning model with input values for at least a subset of the variables associated with at least one animal to generate a predicted value of the dry matter intake for the at least one animal, wherein the input values comprise at least water intake values. Clause 10 can describe the system of claim 9, wherein the machine learning model includes a random forest regression (RFR) model. Clause 11 can describe the system of claim any one of clauses 9 or 10, wherein the input values comprise at least the water intake values, and weight values. Clause 12 can describe the system of claim any one of clauses 9-11, wherein the at least one animal comprises a group of animals, and the input values correspond to aggregated values for the group of animals. Clause 13 can describe the system of claim any one of clauses 9-12, The system of clause 9, wherein the at least one animal comprises a single animal, and the input values correspond to individualized values for the animal. Clause 14 can describe the system of claim any one of clauses 9-13, wherein the instructions, when executed using the at least one processor, cause the at least one computing device to at least: generate a report or a user interface comprising the predicted value of the dry matter intake; and transmit data comprising the report or the user interface to a client device. Clause 15 can describe the system of claim any one of clauses 9-14, wherein the instructions, when executed using the at least one processor, cause the at least one computing device to at least: generate a feed efficiency value for the at least one animal, wherein the feed efficiency value is generated based at least in part on measure of dry matter intake and weight gain for a predetermined time period.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

1. A computer-implemented method of training a machine learning model for determining dry matter intake by animals, comprising:
receiving data comprising values of a set of variables corresponding to a plurality of animals, the set of the variables comprising at least water intake and dry matter intake;
training a machine learning model on the data to provide values of dry matter intake based at least in part on the values of the set of the variables corresponding to the plurality of animals; and
after training, providing the machine learning model with input values for at least a subset of the variables associated with at least one animal to generate a predicted value of the dry matter intake for the at least one animal, wherein the input values comprise at least water intake values.

2. The computer-implemented method of claim 1, wherein the machine learning model includes a random forest regression (RFR) model.

3. The computer-implemented method of claim 2, wherein training the RFR model comprises:
drawing ntree bootstrap samples randomly from the data;
for each of the boostrap samples, generating a regression tree, wherein at each node of the tree, randomly sampling mtry variables of the set of the variables and selecting a best split from the mtry variables; and
wherein predicting the value of dry matter intake includes aggregating predictions of the ntree trees.

4. The computer-implemented method of claim 1, wherein the machine learning model includes a repeated measures random forest (RMRF) model.

5. The computer-implemented method of claim 4, wherein training the RMRF model comprises:
drawing ntree samples based on animal identifiers;
for each of the samples, generating a regression tree, wherein at each node of the tree, randomly sampling mtry variables of the set of the variables and selecting a best split from the mtry variables; and
wherein predicting the value of dry matter intake includes aggregating predictions of the ntree trees.

6. The computer-implemented method of claim 1, wherein the machine learning model includes repeated measures analysis of variance (RM ANOVA) model.

7. The computer-implemented method of claim 1, wherein the set of the variables further include at least one of: a class of animal, body weight, age, average daily gain, duration of in-pen weighing episodes, or any combination thereof.

8. The computer-implemented method of claim 1, wherein the set of the variables further include at least one of: test day, minimal daily temperature, maximal daily temperature, minimum daily relative humidity, maximal daily humidity, average daily humidity, wind speed, maximum daily wind speed, average daily wind speed, W-wave radiation, daily total precipitation, or any combination thereof.

9. A system, comprising:
at least one computing device comprising at least one processor; and
at least one memory comprising instructions executable using the at least one processor, wherein the instructions, when executed using the at least one processor, cause the at least one computing device to at least:
receive data comprising training values of a set of variables corresponding to a plurality of animals, the set of the variables comprising at least water intake and dry matter intake;
train a machine learning model on the data to generate values of dry matter intake based at least in part on the values of the set of the variables corresponding to the plurality of animals; and
provide a trained version of the machine learning model with input values for at least a subset of the variables associated with at least one animal to generate a predicted value of the dry matter intake for the at least one animal, wherein the input values comprise at least water intake values.

10. The system of claim 9, wherein the machine learning model includes a random forest regression (RFR) model.

11. The system of claim 9, wherein the input values comprise at least the water intake values, and weight values.

12. The system of claim 9, wherein the at least one animal comprises a group of animals, and the input values correspond to aggregated values for the group of animals.

13. The system of claim 9, wherein the at least one animal comprises a single animal, and the input values correspond to individualized values for the animal.

14. The system of claim 9, wherein the instructions, when executed using the at least one processor, cause the at least one computing device to at least:
generate a report or a user interface comprising the predicted value of the dry matter intake; and
transmit data comprising the report or the user interface to a client device.

15. The system of claim 9, wherein the instructions, when executed using the at least one processor, cause the at least one computing device to at least:
generate a feed efficiency value for the at least one animal, wherein the feed efficiency value is generated based at least in part on measure of dry matter intake and weight gain for a predetermined time period.
